(19) United States
(12) Patent Application Publication
(10) Pub. No.: US 2016/0338901 A1
(43) Pub. Date: Nov. 24, 2016

(54) Massaging Board Assembly

(71) Applicant: Marcos Isaac Cohen, Los Angeles, CA (US)

(72) Inventor: Marcos Isaac Cohen, Los Angeles, CA (US)

(21) Appl. No.: 14/715,606

(22) Filed: May 19, 2015

(51) Int. Cl. A61H 15/00

(52) U.S. Cl. CPC A61H 15/00; A61H 2015/0042

(57) ABSTRACT

A massaging board assembly about the size of a person's torso containing a series of slots or holes to support two type of mounting brackets: one having an elongated form and the other having and L shape.

The brackets are assembled onto the board to frame a person's back, neck and shoulders. These assembly parts have the property to hold one or more roller ball massager by means of their shape and magnetic nature for enabling a hands-free self massage by a multidirectional movement of the user's own body.

The massaging board assembly is supported by means of stand legs. The board is molded and contoured by hollow square frames to allow the passage of the stand legs. The height of the board can be adjusted by a system of knobs.

### FIELD OF INVENTION

This invention relates to the field of body massaging devices, more specifically to an improved and more focused self-administered ball massager that effectively combines hands-free deep massage therapy, trigger point stimulation and muscle rehabilitation.

### BACKGROUND

This body massager was invented out of the need for a more focalized and deep penetrating massage. By his own experience the inventor of this device wasn't quite satisfied neither with the scope and amount of pressure he could get with other massaging devices or even from the hands of a massage therapist, nor with the time a practitioner spends on each muscle needed to fully relieve his trigger points. First, he experienced self-massage by leaning his back on a tennis ball against the wall. The inventor, which is a certified massage therapist, recognizes the properties and benefits of the ball as an effective instrument for self-massaging. He admits that the pressure is very effective but it needed a method to keep the ball without falling and bouncing to the floor. He came up with a solution to the limitations that any massaging ball can offer by creating a ball holder that contains a magnet to attach the device over a steel surface such as fridge, door, office cabinet or wall bracket.

He also encountered the need for placing the ball in an adequate position to effectively massage especially the top of the shoulders and side of the neck by using an angle bracket.

To avoid that a magnetic massaging device slips away from the structure when pressure is applied, the inventor has successfully tested this method attaching a strong magnet to the back of a roller ball massager's holder and placing it on a stainless steel fridge. After several attempts he discovered that by placing an assembly magnet cup with 65 lbs pull force, about 2.63 inches of diameter and 0.4 inches thick, the device stayed considerably firm while applying pressure. He also encountered that by using an anti-slip rubber magnetic sheet the device had better grasp and it was more likely to remain firm in its place. It has also been tested that with the above dimension of the magnets, the device can be easily removed from one place and put it back to another desire position.

The advantage of having a massage device like this one, is that the user can rely on it at any time of the day and for as long as he or she desires to rapidly relieve any tension of the body without waiting for a professional or any person to assist him/her. By means of its nature, this massaging device is designed to effectively achieve a complete relieve of the muscle's knots followed by an innumerable amount of benefits such as: stimulating blood circulation, eliminating toxins, improving sleep habits, producing endorphins or “happy enzymes” which are neurotransmitters in the brain that act as pain relievers, antidepressant and natural opiates and overall helping to maintain a more youthful appearance.

Orthopedic doctors, chiropractors, massage and physical therapists have long recognized the benefits of deep massage therapy, trigger point stimulation and muscle rehabilitation. These types of therapies are known to be effective in providing relief to people suffering from back and neck pain, pain associated with stress, tension, sports and work related injuries, pain that many women experience during their menstrual cycle. Trigger point stimulation refers to the kneading or rubbing specific reflex points on the body, points where muscles form knots. Many of these points are located in an individual's back or neck and are key areas to relaxing muscles. Muscle rehabilitation occurs when a muscle is deeply massaged, allowing oxygen to flow to the affected area of pain or soreness drawing out lactic acid, thus providing relief. The key to successful trigger point therapy and active muscle rehabilitation depends on the depth of penetration achieved during massage.

It is very important tool for a healthy function of the mind when is used in a work place without the need to take off the clothes. The consistency of the new application of a roller ball massager, allow its users to lean on mostly the entire diameter of the ball. It also offers a not too invasive but a flawless pressure through the muscle's layers where the user can control the pressure needed in a more natural way, as opposed to other hard and rigid electrical devices. The magnetic application of the proposed roller ball massager attached to a steel surface, offers the advantage to massage hands free to mainly all parts of the body, just by leaning against the ball. The only effort that a person makes using this invention is a soft movement of the body. The possible movements can be as follow: swiveling the trunk, bending knees, lifting shoulders, making circular motions with the hip, rotating the head, swinging a knee, arm, leg or even a foot depending of which part of the body needs work.

This invention comparing with other massaging apparatus, probes that is more organic than other massaging devices. Some of the drawbacks encountered by exploring other massaging devices were that the pressure they offer could be too mechanical or limited to a fixed programmable speed, receiving either a too soft or a too aggressive touch. With the proposed invention, the user has more control on the pressure he or she desires, really focusing in one spot at a time.

Previous inventions utilize balls, which spin around axles. A ball on an axle can only move in one direction or plane, thus limiting the effectiveness of the massage. This invention also provides an affordable massaging device for all people by nature of its simple design and cost of manufacture.

The drawings here presented, show the process and derivation of the invention after assessing the results of a pilot metallic apparatus presented in the provisional application. The inventor along with this process found many derivations or multiple applications of the apparatus to use the assembly parts separately in different environments: home, office or gym.

For example, the roller ball massager can be used separately on a fridge. Also, by taking apart the mounting brackets from the massaging board assembly, the massage can be applied against a doorframe, wall or a column, to effectively massage hands-free the neck and upper part of the shoulders. The benefit that the angles of the L shape bracket offer is that they allow to position the body in a more comfortable way and give space to the head and shoulders to move freely during the massage.

The need of this massaging board assembly comes out from the fact that not all the refrigerators were built with magnetic field. Therefore, the inventor came up with this idea especially created to complement the use of the roller ball in any part of a home or office without occupying much space. Many companies reward their employees with this type of perks, probing to be very beneficial to increase productivity.

The invention can also be used in public spaces, like gyms. For this environment, people can alternate their work out with a self-massage using the device.

The inventor also recommends following the instructions on a video or manual to guide the user step by step, on how to use the invention in a more safe and efficient way.

### SUMMARY, RAMIFICATIONS AND SCOPE

Thus the reader will see that this invention allows its user to deeply massage oneself on barely all parts of the body in a very effective way. With any other regular massage ball, the chances of sliding and falling are very high, especially when using a wall corner to massage either the upper shoulder or the neck. We mentioned before the importance to have the right angle to massage these parts of the body. The solution of the magnetic application to a massage ball, is justified by the fact that the ball in itself is not steady, it can fall and bounce. The improvement that the invention offers focus exclusively on the nature of a ball, which in itself has therapeutic properties but it has limitations in terms of its application.

The proposed invention doesn't require batteries or electricity making it more natural and eco-friendly due to the mechanism of the user's own body.

Men, women and even children can benefit from this device regardless their height or size. Additional advantages are that it is very economical to produce, making it affordable to millions of people. It is also durable, lightweight, self-administered, very simple to use, it doesn't occupy much space and can be used in different environments: house, garage, office, spa or gym.

It is designed to effectively relieve trigger points, increase blood circulation, and rehabilitate muscles by eliminating toxins and metabolic waste. It is also a very powerful tool for corporation use to increase productivity of the employees at their place of work. It can be also a very important tool at gyms where the members can alternate their workout with a self-massage. After they try it, they can buy the device at the gym for home use.

Furthermore, the magnetic roller ball can be sold in different colors to offer the benefit of having an individual ball for each family member or for each business' employee.

While this description contains many specifications, these should not be construed as limitations on the scope of the invention, but rather as an exemplification of preferred embodiments of this invention. Many other variations are possible for example different colored and materials can be used to make the roller ball and ball holder and various combinations of materials can be used to make the board, the mounting brackets or the standing legs. And the process to assemble the parts or to adjust the height of the board can be applied in many modalities, in any order for multiple purposes. Therefore I claim, the product comprising any feature described either individually or in combination with any feature, in any configuration.

Thus, the scope of the invention should be determined by the appended claims and their legal equivalents, rather than by the examples given.

### BRIEF DESCRIPTION OF DRAWINGS

For detailed description of a preferred embodiment of the invention, refer to the accompanying drawings:

FIG. 1 Shows a frontal plan view of the invention.

FIG. 2 Is a 3-D side/top view from the left of the invention.

FIG. 3 Is a 3-D partial view of the invention showing how the mounting parts may be assembled.

FIG. 4 Is a 3-D side/back view from the left of the invention.

FIG. 5 Shows a side view of the invention.

FIG. 6 Is a 3-D bottom view of the invention.

FIG. 7 Shows a frontal plan view of the mounting bracket having an elongated form and the roller ball massager in accordance with the present invention.

FIG. 8 Is a partial side/top view of the mounting bracket having an elongated form with the roller ball massager in accordance with the present invention.

FIG. 9 Is a 3-D back view of the mounting bracket having an elongated form with roller wheels in accordance with the present invention.

FIG. 10 Is a perspective bottom view of the roller ball massager with the magnetic application in accordance with this present invention.

FIG. 11 Is an exploded bottom view of the roller ball massager showing the assembly parts of the magnetic application in accordance with the present invention.

FIG. 12 Shows a transversal cut frontal view of the roller ball massager with the magnetic application in accordance with the present invention.

### REFERENCE NUMERALS IN DRAWINGS

13 Board.
14 Elongated bracket.
15 L shape bracket.
16 Ball holder.
17 Handle.
18 Stand leg.
19 Transversal stand tube.
20 Foot.
21 Foot knob.
22 Roller wheel.
23 Screw knob.
24 Board screw hole.
25 Bracket screw hole.
26 Handle base.
27 Roller wheel lock.
28 Bracket key hole.
29 Bracket lock hole.
30 Ball.
31 Assembly magnet cup.
32 Magnet.
33 Ball holder screw hole.
34 Nut.
35 Screw.
36 Ball support disc.
37 Wall shield.
100 Groove.
101 Roller wheel frame.
102 Roller wheel notch.
103 Handle pivot pin.

### DETAILED DESCRIPTION OF THE INVENTION

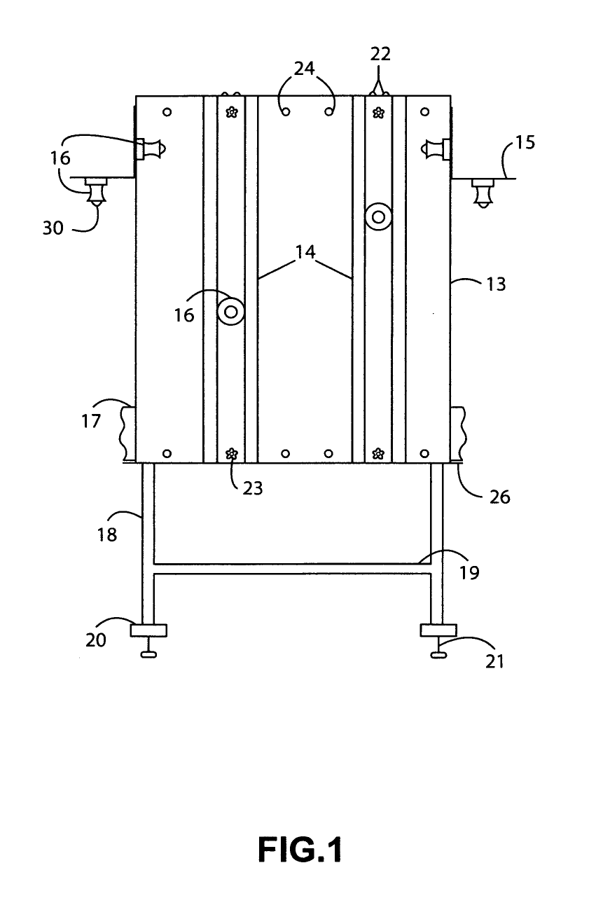

Referring to FIG. 1, there is shown a plan view of the preferred embodiment of the Invention. The apparatus shown in FIG. 1 is comprised of a rectangular board 13 about the size of a person's torso, made out of plastic material such as HDPE, polypropylene, fiberglass, or something of the like. It contains a series of screw holes to attach mounting brackets in several positions. These brackets can hold one or more roller ball massager for enabling a hands-free self massage by a multidirectional movement of the user's own body. The invention proposes two types of brackets: elongated bracket 14 and L shape bracket 15. The elongated bracket 14 can be adjusted from side to side in a horizontal direction, while the L shape bracket 15 does it in a vertical direction by the side of the board 13. Both type of brackets are made out of metal steel material, about 20 gauge of thickness.

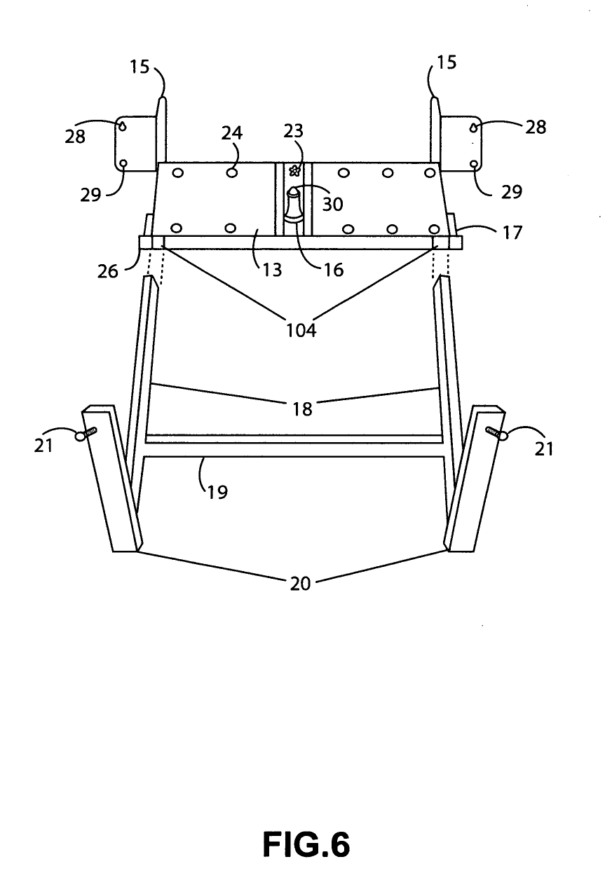

The board 13 is molded and contoured by hollow square frames to allow the passage of stand legs 18. The height of the board 13 can be adjusted rotating the lateral screw knobs 23 at the bottom and on each side of the massage board 13. When the knob 23 is rotating in one direction the screw will press the stand leg 18 against the back of plastic frame of the board 13. A clearer view of this system is illustrated in FIG. 6.

The stand is composed by three square metal tubes, two vertical stand legs 18 and one transversal stand tube 19 to keep the structure balanced. At the bottom of the stand legs 18, are shown the metal feet 20 about the same thickness, standing outwardly from the back to allow support and balance. The foot 20 contains a foot knob 21 to adjust the inclination of the board 13.

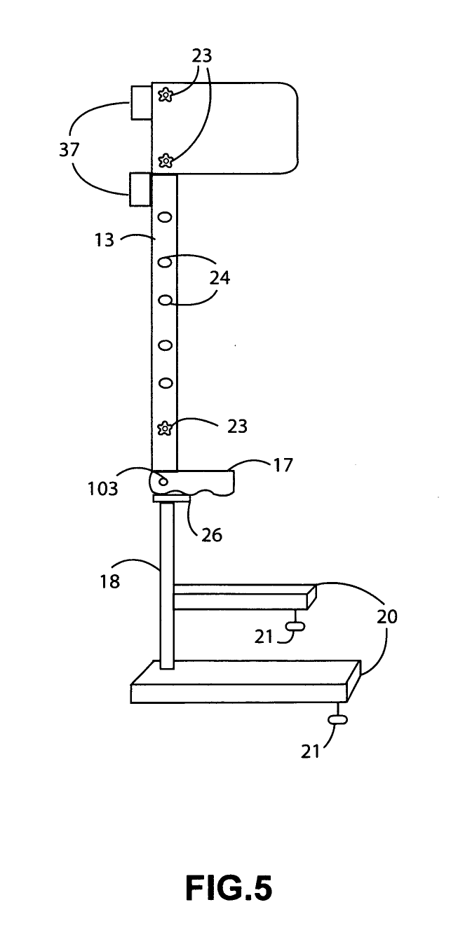

This can be understood better by seeing FIG. 5 in which shows a side view of the invention. At the bottom of the feet 20, are shown a pair of feet knobs 21. By rotating these knobs 21, the board 13 can be inclined to the back until the wall shields 37, located at the back of the board, touch the wall. These feet knobs 21 are made of plastic or rubber and they also serve to protect the floor from scratches.

The system described here would allow a person to use the board by leaning against a background surface (E.g. wall or door) without the need for drilling or damaging such surface.

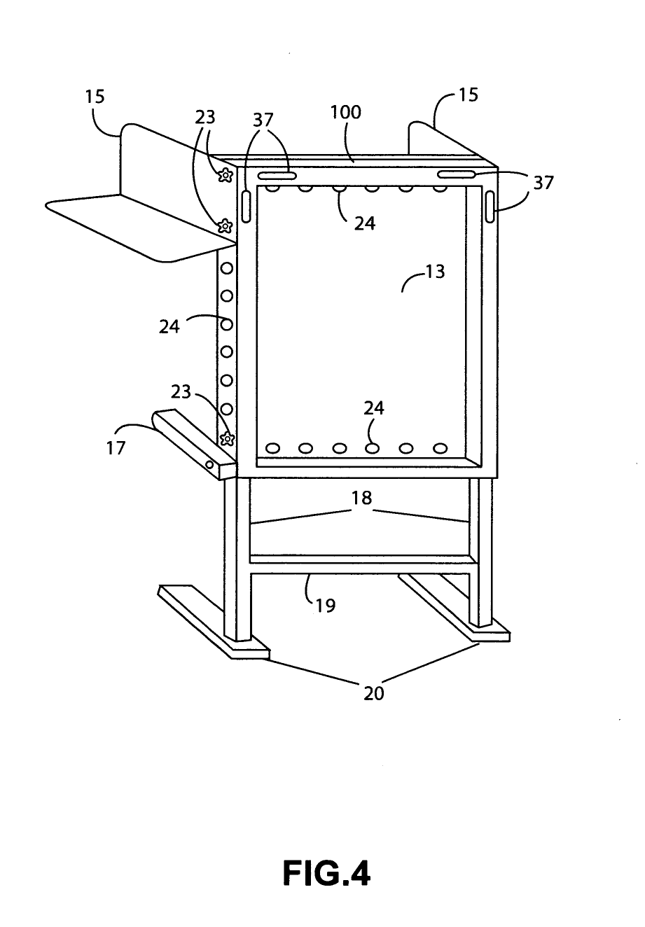

FIG. 4 shows a back/side of the invention with the frames embossed toward the wall leaving a hollow space, which is the back of the board 13. On the corners, are shown the wall shields 37 which serve to protect the wall from damages when the person leans back against the device.

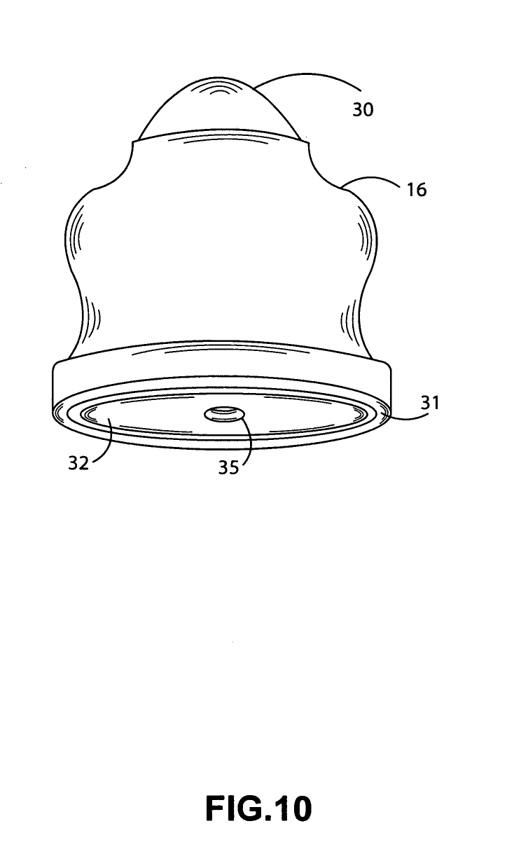

FIG. 10 shows an embodiment of the proposed roller ball massager comprised of a ball 30, of a rigid material such as resin or the like embedded in a ball holder 16 made out of a plastic material similar to the board 13, which contains an assembly magnet cup 31 with a magnet to attach the device against the mounting brackets according to the proposed invention or on any steel surface (E.g. fridge, metal cabinet, door, wall corner protector.) The diameter of the assembly magnet cup 31 is about 2.63″ and a magnet 32 about 0.4″ thick with 60 lbs pull force, strong enough to have good grasp but light enough to easily slide on the metal surface when the user needs to adjust the height to a new desired position.

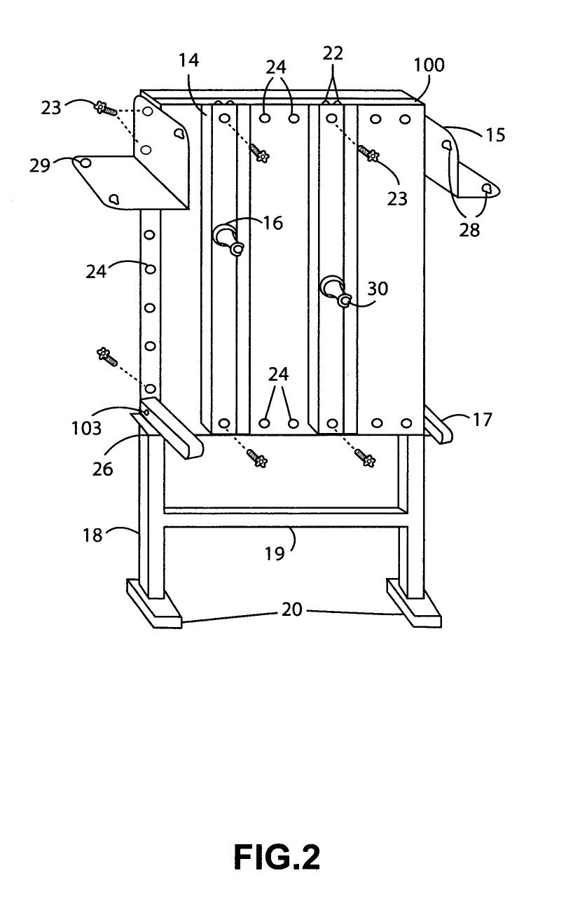

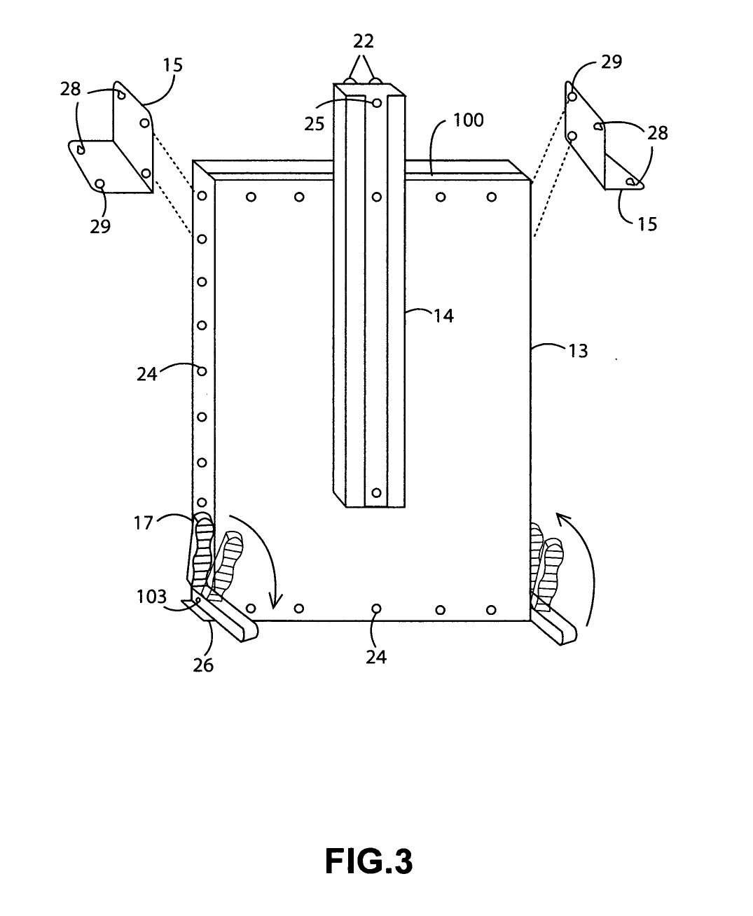

FIG. 2 and FIG. 3 show a 3-D view of the invention from the top of board 13 in which we can see a groove 100 like a rail area where the elongated bracket 14 can be placed and slid from side to side by means of roller wheels 22.

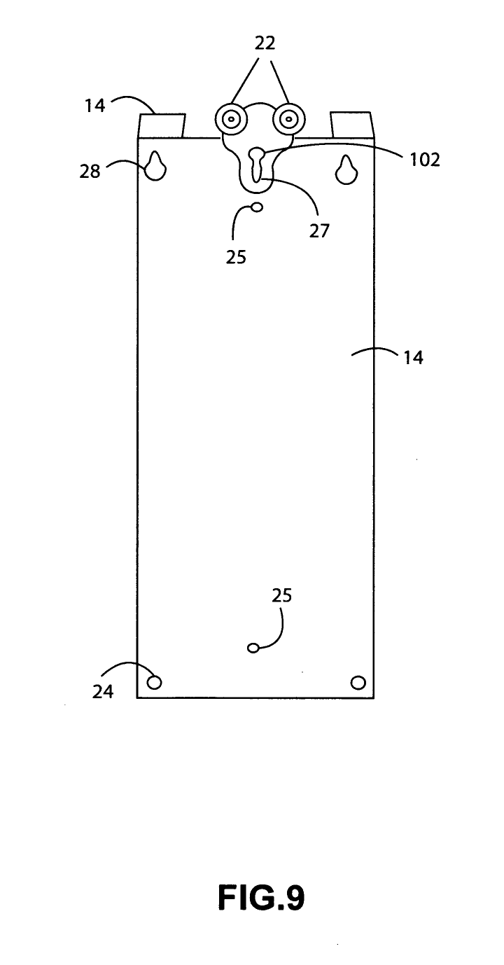

FIG. 9 shows a clearer view of this mechanism where the roller wheels 22 are part of a roller wheel frame 101 that contains an open area or a notch 102 where a lock 27 at the back of the mounting bracket is inserted and locked, whereby the roller wheels 22 are coupled on the groove 100 to change the position of the mounting brackets.

In FIG. 2 shows a 3-D view of the invention from the top where we can see the perspective of the mounting brackets. There are two L shape brackets 15 attached to the top of the board 13 by means of screw knobs on the side of the bracket. From this perspective we can clearly see how the apparatus frames a person's neck, shoulders and torso.

The elongated bracket 14 is designed with an open space at the top to easily remove the roller ball massager if the user desires to operate it manually or against a metal steel surface such as refrigerator, metal cabinet, etc.

FIG. 3 shows the mechanism of the handles 17 at the side of the board 13 which serve as a support for the user especially when massaging the upper part of the body like shoulders, in order to get more stability and prevent the board 13 to be lift up. The handle 17 is sustained by means of a handle base 26 which can be a protruding portion of the board 13 to secure a firm grasp.

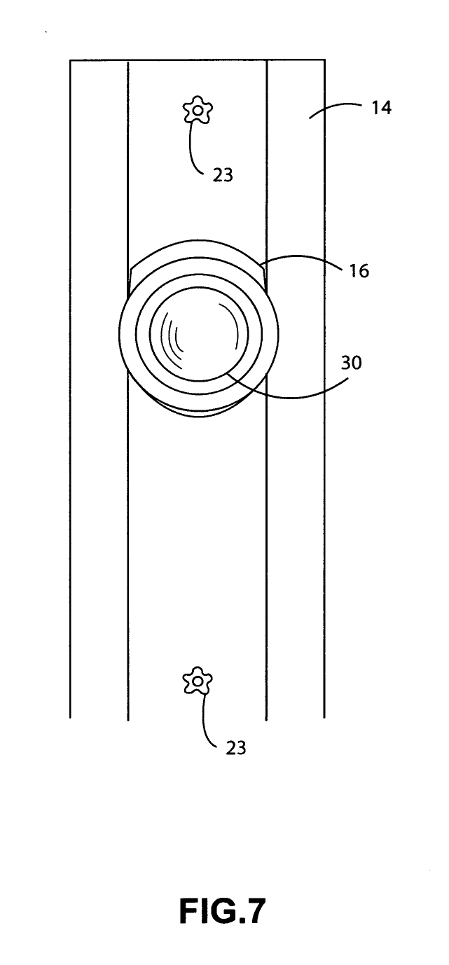

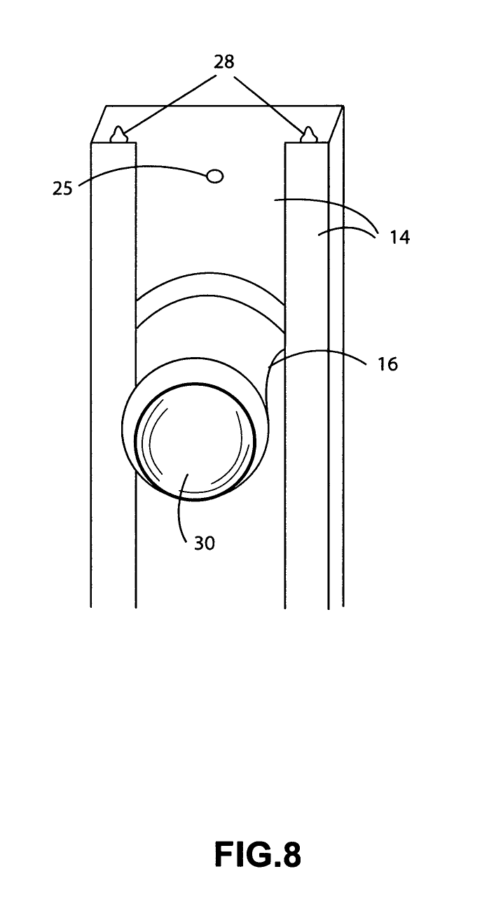

FIGS. 7 and 8 show the mechanism of the elongated bracket 14 having a sliding track on the back surface and two folding frames where the roller ball massager is recessed. By means of the magnetic properties, the roller ball massager can be held without falling. At the same time, it allows a user to move the device upward or downward through the sliding track surface.

FIG. 9 shows two key holes 28 at the top back part of the elongated bracket 14 to hang it against a wall or frame in which the screws can get locked within the narrow part of the key holes 28. It also shows a small hole 25 wherein a screw knob 23 comprised of a plastic head and a screw can fasten the elongated bracket 14 against the board or another background surface (E.g. wall, door frame, etc.) This method allows the user to easily mount and dismount the bracket from the supporting background surface. It also gives the option to hang it in a lower position using two extra screws positioned at the bottom of the mounting brackets, which are locked by the lock holes 29 at the bottom of the elongated bracket 14. For this new lower position, the bottom screws would be the upper screws locked now by the key holes 28.

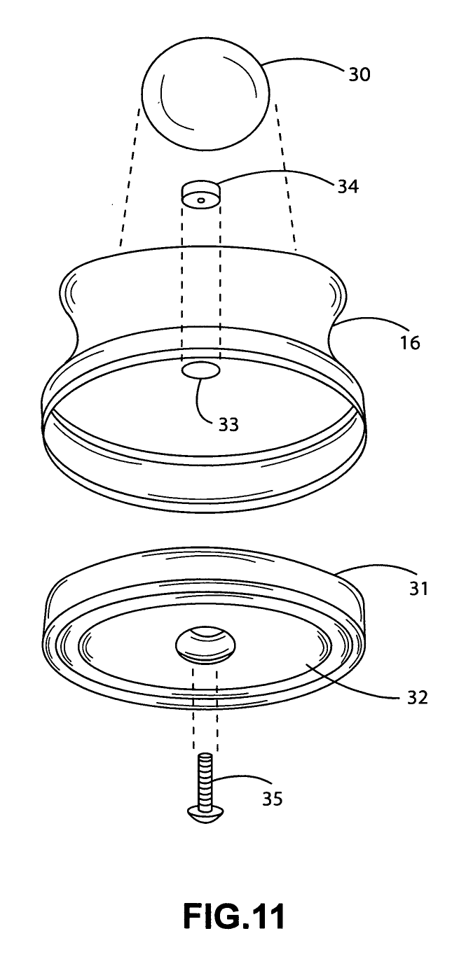

FIG. 11 shows how the roller ball is assembled, first by placing the assembly magnet cup 31 in its base with the help of a screw 35 and nut 34 and then embedding the ball 30 inside the ball holder 16.

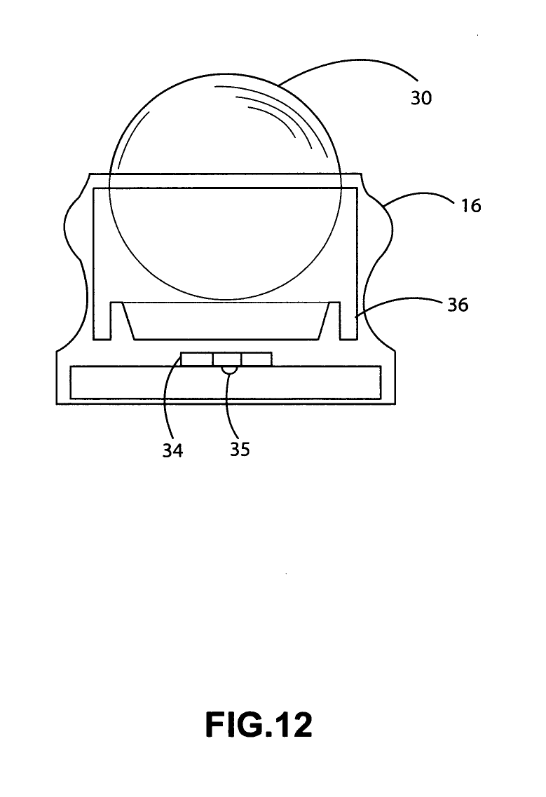

FIG. 12 shows a transversal cut of the roller ball where the ball 30 is supported by a support ball disc 36 allowing a multidirectional movement inside the ball's holder 16. This mechanism is considered to be in the state of the art.

### OPERATION

The present invention allows a hands-free self-massage on areas of the body that are hard to reach like the upper part of the shoulders or by the shoulder blades. It also offers the experience of a very deep penetrating feeling into the muscles in a more organic and natural way. In other words, a person can control the pressure needed using his or her own body mechanism.

It also has the advantage to focus on one muscle at a time, applying pressure on specific key trigger points, which is most recommended to obtain better results.

The methods for using this assembly massage board 13 are described. With board 13 placed against the wall an individual adjust the height of the board 13 where the base of the L shape brackets 15 meet the person' shoulders for a more comfortable position. Then, the person places the roller ball massager about the middle of the elongated bracket 14 to massage the upper part of the back. Gently the person bends the knees and leans the back against the massaging device until the board 13 touches the wall. This device is intended to massage mostly all parts of the body: lower, middle, upper back and the muscles around the shoulder blades. It can also be used for gluteus, arms, legs and even feet.

The user now begins to swivel his or her trunk in any directions (circular, vertical or horizontal), which causes the roller ball massager to rotate within the ball holder 16. At this point the user experiences a very real, more focused and effective deep tissue massage.

This invention also offers the possibility to assemble the parts when massaging the shoulders leaving a more spacious surface when massaging the back. In this manner, the person can raise and move the arms more freely without collapsing with the L shape brackets 15. Besides the back, a person can massage his or her legs or arms by standing sideways from the board 13 by lifting, swinging and flexing knees, elbows or shoulders.

The L shape brackets 15 can also be lowered to massage side of the torso.

The space between the L shape brackets 15 is spacious enough to accommodate a person's head and allowed a comfortable movement and rotation of the neck. It gives the option to separate the board 13 from the stand legs 18 and use on a chair if the user desires to apply the massage in a sitting position. However, the inventor recommends using it in a standing position for better results.

Another important advantage of this invention is the possibility to massage an intimate part of the body, for example the gluteus. Even most of the practitioners may not dare to reach certain parts of the body like the groin or gluteus. But with this invention, the user can freely experience an intimate massage without feeling intimidated by the hand of a therapist working on those areas. In order to do this, the user must place the roller ball device at the bottom of the board 13. Then the person leans his or her trunk forward holding the hands on the back of a chair or on a table. Pressing the gluteus against the massaging device the person swivels the hips in a circular motion finding the knots and relieving the tension around the area.

The invention also allows massaging the feet. First, the user must adjust the board 13 at the lowest level of its height. Afterwards, he or she lies on his or her back using a mat against the floor. By placing the plant of the foot against the massaging device, the user can move the foot and leg up and down or in a circular motion to get an effective and pleasant foot massage.

What is claimed:

1. A massaging board assembly, comprising means to support mounting brackets, said brackets having a particular shape to frame a person's back, neck and upper part of the shoulders on a vertical or horizontal position, said brackets having means to hold one or more roller ball massager for enabling a hands-free self massage by a multidirectional movement of the person's own body.

2. The massaging board assembly of claim 1 having two hollow vertical frames on the side and back of said board, and two horizontal frames on top and bottom of the back of said board wherein a pair of vertical stand legs can be inserted within said hollow vertical frames and fastened by a system of knobs or the like, said vertical stand legs connected by a transversal stand tube, whereby said board can be placed on a standing position against a background surface (E.g. wall or door) and properly adjusted to the height of the user.

3. The stand legs of claim 2 having feet to maintain proper balance of the said board in claim 1, said feet having a screw hole at the bottom, wherein a screw knob is inserted to adjust the inclination of the said board in claim 1, whereby said massaging board assembly can be leaning against a background surface (E.g. wall or door.)

4. The massaging board assembly of claim 1 wherein said hollow vertical and horizontal frames in claims 1 and 2 contain means to protect any background surface from scratches when the user leans over.

5. The massaging board assembly of claim 1 having a groove wherein said mounting brackets can be placed and slid from side to side by means of roller wheels attached to the back of said mounting brackets whereby a user can adjust the position of the roller ball massager for self-massaging.

6. The roller wheels of claim 5 further comprising a mounting frame fixedly fastened to position said mounting bracket for sliding side to side on said groove of said massaging board assembly in claim 1.

7. The massaging board assembly of claim 1 wherein one of said mounting brackets having an elongated form with a sliding track on the back surface, and two lateral folding frames wherein said roller ball massager is recessed, said mounting brackets containing means to grasp the roller ball massager while the massage is applied, whereby a user can manually slide the roller ball massager through said sliding track to a desired position for self-massaging.

8. The mounting bracket of claim 7 having a lock to hold said roller wheels in claim 5, said mounting bracket having screw key holes at the top and lock holes at the bottom, whereby a user have the alternative to attach said mounting bracket for example against a wall, column or door frame.

9. The mounting bracket of claim 7 having a screw knob hole at the top and a screw knob hole at the bottom wherein a screw knob is inserted to support and fasten said mounting bracket against said massaging board assembly in claim 1.

10. The mounting bracket of claim 7 having an open surface at the top and the bottom wherein said roller ball massager can be slid and removed from said mounting bracket, whereby a user can have the alternative to operate the massage manually.

11. The massaging board assembly of claim 1 wherein two of the said mounting brackets having an L shape with a flat surface, said L shape bracket having means to be attached into said massaging board assembly, whereby a user can remove and place said L shape brackets in different positions alongside said massaging board assembly to effectively massage neck, upper shoulders and side of torso.

12. The L shape bracket in claim 11 containing means to hold said roller ball massager in claim 1 to remain hanging outward or sideways whereas the massage is applied to the back or sides of the neck, or hanging downward whereas the massage is applied on top of the shoulders.

13. The L shape bracket in claim 11 having screw key holes at the top and lock holes at the bottom, whereby a user have the alternative to attach said mounting bracket for example against a wall, column or door frame.

14. The massaging board assembly of claim 1 having means to support a pair of handles, whereby a user can hold onto while applying the massage to obtain better stability of said board, said handles having means to pivot around an axle to position said handles upward or downward by the sides of said massaging board assembly.

15. The roller ball massager of claim 1 comprising a ball embedded in a ball holder, said ball holder having a ball support disc, said ball holder having a hollow surface wherein a magnet is embedded and fastened, all these elements adapted and improved to attach said roller ball massager steadily on said mounting brackets assembled on said massaging board assembly in claim 1 or on any steel metal surface (E.g. fridge, door, office cabinet, or corner protector), whereby a person can achieve a hands-free multidirectional movement of the body for self massaging.
